(19) United States
(12) Patent Application Publication
(10) Pub. No.: US 2008/0023948 A1
(43) Pub. Date: Jan. 31, 2008

(54) GAS GENERATOR FOR RESTRAINING DEVICE FOR VEHICLE

(75) Inventors: Kenji KITAYAMA, Tatsuno-shi (JP); Nobuyuki OHJI, Tatsuno-Shi (JP); Masato HIROOKA, Tatsuno-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-shi (JP)

(21) Appl. No.: 11/772,694

(22) Filed: Jul. 2, 2007

Related U.S. Application Data
(60) Provisional application No. 60/833,844, filed on Jul. 28, 2006.

(30) Foreign Application Priority Data
Jul. 27, 2006 (JP) 2006-204076

(51) Int. Cl. B60R 21/26

(52) U.S. Cl. 280/736

(57) ABSTRACT

The present invention relates to a gas generator for a restraining device for a vehicle comprising a combustion chamber accommodating a solid gas generating agent therein, an igniter for igniting and burning the solid gas generating agent, the solid gas generating agent having a columnar shape and a through hole in the central portion thereof in the longitudinal direction, an ignition portion of the igniter being disposed to face one end surface of the solid gas generating agent, an outer diameter of the ignition portion being smaller than an outer diameter of the solid gas generating agent and larger than an inner diameter of the through hole.

This nonprovisional application claims priority under 35 U.S.C. § 119(a) on Patent Application No. 2006-204076 filed in Japan on 27 Jul. 2006, and 35 U.S.C. § 119 (e) on U.S. Provisional Application No. 60/833,844 filed on 28 Jul. 2006, which are incorporated by reference.

### BACKGROUND OF INVENTION

1. Field of Invention

The present invention relates to a gas generator for a restraining device for a vehicle, such as an air bag apparatus.

2. Description of Related Art

In gas generators using a solid gas generating agent, a lump-like gas generating agent is sometimes used with consideration for easiness of loading the gas generating agent.

U.S. Pat. No. 5,685,558 discloses an inflator using a lump-like gas generating agent. In an inflator 44 shown in FIG. 3, a chamber 144 accommodating a pressurized fluid is connected to two combustion chambers 180, 182 that are provided with igniters 186, 188 activated independently from each other, and gas generating agents 184 burnt by the respective igniters, respectively.

The gas generating agent 184 has a lump-like shape (single-perforated tubular shape) having a through hole, and each of the igniters 186, 188 is disposed inside the through hole of the gas generating agent 184. Therefore, the gas generating agent 184 has a structure such that the gas generating agent faces each of the igniters 186, 188 only at the inner peripheral surface of the through hole.

### SUMMARY OF INVENTION

The present invention relates to a gas generator for a restraining device for a vehicle including a combustion chamber accommodating a solid gas generating agent therein,

an igniter for igniting and burning the solid gas generating agent,

the solid gas generating agent having a columnar shape and a through hole in the central portion thereof in the longitudinal direction,

an ignition portion of the igniter being disposed to face one end surface of the solid gas generating agent,
an outer diameter of the ignition portion being smaller than an outer diameter of the solid gas generating agent and larger than an inner diameter of the through hole.

### BRIEF DESCRIPTION OF DRAWINGS

The present invention will become more fully understood from the detailed description given hereinbelow and the accompanying drawings which are given by way of illustration only, and thus are not limitative of the present invention and wherein:

FIG. 1 shows an axial sectional view of the gas generator in accordance with the present invention;

FIG. 2 shows a partial sectional view in the axial direction of an igniter for use in the gas generator shown in FIG. 1;

FIG. 3 shows a plan view of a solid gas generating agent that can be used in accordance with the present invention; and

FIG. 4 shows a plan view of another solid gas generating agent that can be used in accordance with the present invention.

### DETAILED DESCRIPTION OF INVENTION

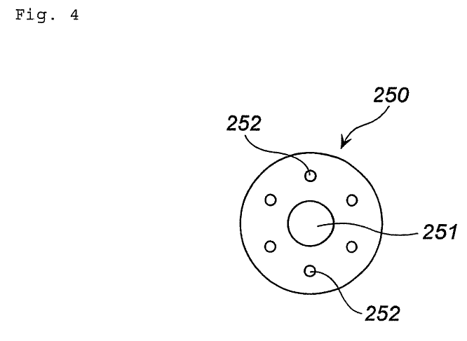

The results of tests conducted by the inventors of the present invention demonstrated that in the case of a structure in which an igniter is disposed inside a hole provided in a lump-like gas generating agent, as shown in FIG. 3 of U.S. Pat. No. 5,685,558, the output of the gas generator varies.

This variability in the output can be explained as follows. The flame generated by the igniter propagates linearly and easily passes inside the through hole, thereby making it difficult for the flame to come into contact with the inner surface of the gas generating agent. As a result, the non-combusted gas generating agent is remained to be discharged from the combustion chamber. A non-combusted part of the gas generating agent happens to be discharged from the combustion chamber when it remains non-combusted in part.

The present invention provides a gas generator for a restraining device for a vehicle, suitable for an air bag apparatus, in which the ignition ability in the case of using a lump-like gas generating agent is improved, a stable output can be ensured, the output increases rapidly, and the maximum output can be increased.

The degree of combustion of the solid gas generating agent affects an output of the gas generator. Therefore, the faster is the combustion of the solid gas generating agent, the higher is the maximum output of the gas generator. This is because the energy of the generated gas can be used efficiently. And in order to obtain this effect, it is preferred that the solid gas generating agent is broken into pieces.

In the case of the conventional structure disclosed in U.S. Pat. No. 5,685,558, the combustion product (flame, high-temperature gas, shock wave, etc.) generated by combustion at the igniter passes through the through hole and easily reaches the opposite end portion of the solid gas generating agent. In particular, when the through hole is large, the combustion product more easily pass through to the opposite end portion. Because the combustion product thus easily passes through the thorough hole, the breaking effect is deteriorated and the output of gas generator is decreases.

On the other hand, when there is a specific diameter relationship between the ignition portion and the solid gas generating agent, as described in the present invention, the opposing surface area of the solid gas generating agent against which the combustion product collides increases. As a result, the solid gas generating agent that has a lump-like shape is easily broken into pieces and the maximum output is increased. Because the solid gas generating agent in accordance with the present invention has a through hole, part of combustion product passes through the through hole and out to the opposite end, but due to the above-described special diameter relationship, a sufficient breaking effect is demonstrated.

Using a grained gas generating agent from the beginning is effective if rapid burning of the gas generating agent is desired, but lump-like solid gas generating agents are superior because they are easy to handle in the manufacturing process, ensure a high filling efficiency of a gas generating agent (amount charged per unit volume), and enable decrease in size.

In the invention of claim 1, by using a solid gas generating agent that has a through hole in the longitudinal direction in the central portion thereof and setting a relationship between solid gas generating agent and the ignition portion of the igniter, it is possible to impart the solid gas generating agent with good strength, maintain good combustion state and gas generation state, and maintain a stable output. Further, a booster or a transfer charge that enhance ignition and combustion of the gas generating agent can be used separately from the ignition agent charged into the ignition portion of the igniter, but for the invention with a better effect, it is preferred that no such booster of transfer charge be present between the ignition portion and solid gas generating agent.

The solid gas generating agent has a columnar shape and may have a round cross section or a polygonal or elliptical cross section close to a round one. At least a single through hole is provided therein, and a plurality of through holes may be provided. When there is a single through hole, the through hole is present in the central portion of the end surface, and even when there are a plurality of through holes, one through hole is located in the center of the end surface. No specific limitation is placed on the sectional shape of through hole in the width direction, and a through hole of a round, polygonal, or elliptical cross section can be used, but a round one is preferred.

The solid gas generating agent may be also obtained by arranging and combining a plurality of columnar solid gas generating agents on a circle so as to obtain a generally columnar shape having a through hole in the longitudinal direction. For example, it is possible to use six to ten columnar gas generating agents (having no through hole) and dispose them on a circle so that the adjacent columns are brought into contact with one another, thereby providing a through hole in the central portion, or to mold them integrally to have a similar shape.

The solid gas generating agent used in accordance with the present invention is a single unit, and even when a plurality of solid gas generating agents are used in combination on a circle, as described hereinabove, these solid gas generating agents are brought into contact with one another and form a single solid gas generating agent as a whole. Further, a columnar configuration that is obtained by stacking, in the axial direction, a plurality of disk-like solid gas generating agents having a through hole in the central portion thereof is not included.

The ignition portion of the igniter serves to generate a combustion product during actuation. And in the ignition portion, an ignition agent is charged into a container such as a cup member. The ignition portion of the igniter and the end surface of the solid gas generating agent may be in contact with each other or may face each other via a gap, but it is preferred that they be disposed directly opposite each other via a gap. Further, the central axis of the ignition portion coincides with the central axis of the through hole of the solid gas generating agent. As a result, the combustion product readily propagate through the entire through hole.

As described above, the ignition portion of the igniter is obtained by forming an outer shell from a container such as a cup member and charging an ignition agent into the outer shell. Therefore, for example, when an ejection port that can be ruptured is provided in the bottom surface of the cup member and the combustion product is discharged only from the ejection port, the diameter of the ejection port becomes “a true outer diameter” of the ignition portion and the outer diameter of the cup member becomes “an apparent outer diameter” (the true outer diameter is smaller than the apparent outer diameter). Further, in the case where the entire bottom surface of the cup member is fractured to discharge the combustion product, the combustion product is discharged from the surface of the same area as the bottom surface. Therefore, the outer diameter of the ignition portion matches the outer diameter of the cup member (using the aforementioned example, the true outer diameter is equal to the apparent outer diameter). Even in the case where the true outer diameter is equal to the apparent outer diameter, the true outer diameter becomes smaller by the thickness of the cup member, but the thickness of the cup member is very small and can be ignored.

The outer diameter of the ignition portion of the igniter is smaller than the outer diameter of the solid gas generating agent (in the case of having a polygonal, that is, non-round, cross section, the outer diameter of the solid gas generating agent is a diameter of the circle connecting all apexes, and in the case of an ellipse cross section, the outer diameter is a longer diameter) and larger than the inner diameter of the through hole (when the through hole is in the form of a polygon with four or more corners, the inner diameter is the maximum diameter, and in the case of an ellipse, the inner diameter is a longer diameter). When the outer diameter of the ignition portion of the igniter satisfies the aforementioned relationship in which the true outer diameter is smaller than the apparent outer diameter, the outer diameter of the solid gas generating agent has to be larger than the true outer diameter, the inner diameter of the through hole has to be smaller than the true outer diameter, and the inner diameter of the through hole has to be smaller than the apparent outer diameter.

With such a configuration, the ignition portion is prevented from entering the through hole, and when the igniter is actuated, the combustion product generated from the ignition portion unavoidably come into contact with one end surface of the solid gas generating agent and also with the inner wall surface of the through hole. As a result, the ignition ability of the solid gas generating agent is improved as compared with that of the invention (FIG. 3) of U.S. Pat. No. 5,685,558, and the solid gas generating agent is easily broken into pieces by the impact wave from the igniter. As a result, no non-combusted product is generated.

The present invention further relates to the gas generator for a restraining device for a vehicle, wherein at least part of circumferential surface and part of end surface of the solid gas generating agent is brought into contact with an inner wall surface of the combustion chamber, thereby preventing the solid gas generating agent from moving in the axial direction and the radial direction.

With such configuration, the solid gas generating agent is prevented from colliding with the inner wall of combustion chamber and generating abnormal noise. Furthermore, the solid gas generating agent is prevented from being pulverized by repeated collisions.

Where a gap is present between the solid gas generating agent and the inner wall of the combustion chamber, depending on the gap occurrence conditions, the contact state of the solid gas generating agent and the combustion product can become non-uniform. As a result, the combustion state also becomes non-uniform, causing variability in the output of gas generator.

From the standpoint of solving the above mentioned issue, in the invention, it is preferred that the entire circumferential surface and at least a circumferential edge portion of one end surface of the solid gas generating agent be brought into contact with the inner wall of the combustion chamber, thereby preventing the solid gas generating agent from moving inside the combustion chamber. Where the entire circumferential surface of the solid gas generating agent is brought into contact with the inner wall of combustion chamber, the combustion product is prevented from coming into contact with zones other than the end surface and inner wall surface of the through hole of the solid gas generating agent (for example, the inner wall surface of combustion chamber) and the combustion state can be easily controlled. As a result, in addition to the above-described movement preventing effect, a contribution can be also made to suppression of variability in the output.

The present invention further relates to the gas generator for a restraining device for a vehicle, wherein the ignition portion has a cylindrical charge holder and an ignition agent loaded into the cylindrical charge holder, and the cylindrical charge holder and the ignition agent are covered with a cup member, and an inner diameter of the charge holder is larger than an inner diameter of the through hole.

When the ignition portion has a charge holder, as described above, the ignition ability of the solid gas generating agent is improved by satisfying the aforementioned relationships. If the outer diameter of the ignition portion is defined like in the example described in invention of above claim 1, the inner diameter of the charge holder becomes the true outer diameter, and the outer diameter of the cup member becomes the apparent outer diameter.

Yet another advantage of having the charge holder is that the ejection direction of combustion product can be controlled to the opening direction of the charge holder. As a result, the combustion product can be concentrated on one end surface of the solid gas generating agent present in the opening direction, and the breaking effect of the solid gas generating agent is enhanced.

Because the gas generator in accordance with the present invention uses a lump-like solid gas generating agent, the operation of charging a gas generating agent when the gas generator is assembled is facilitated and the ignition ability of the solid gas generating agent is improved. Therefore, the output during actuation of gas generator can rise faster, the maximum output can be raised, and the output can be stabilized.

### EMBODIMENTS OF INVENTION

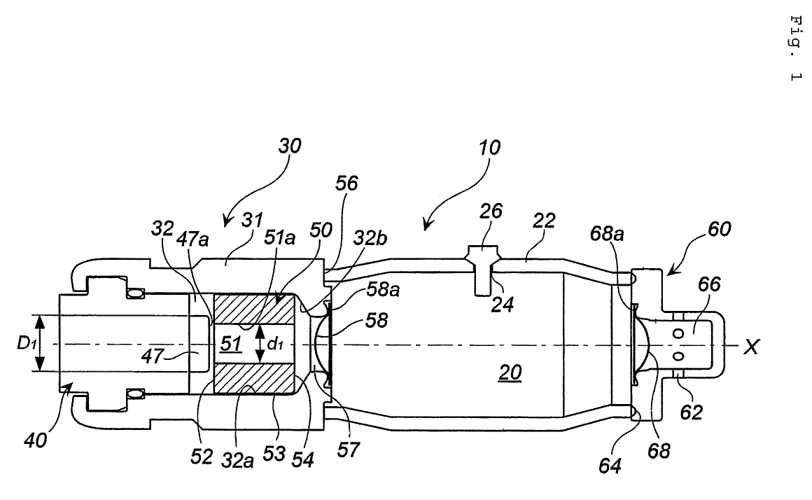

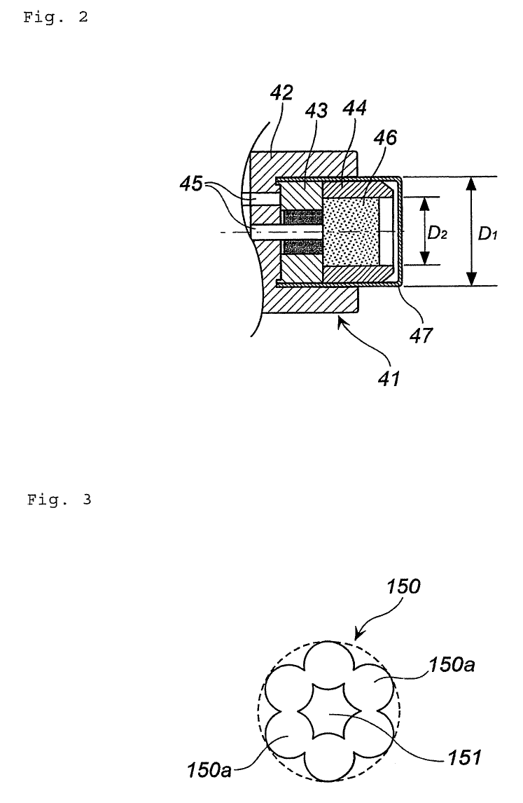

A gas generator in accordance with the present invention will be explained below with reference to FIG. 1 to FIG. 4. FIG. 1 is a cross-sectional view in the axial direction of the gas generator of the present invention. FIG. 2 is a cross-sectional view in the axial direction of the igniter used in the gas generator shown in FIG. 1. FIG. 3 and FIG. 4 are plan views of a solid gas generating agent that can be used in the gas generator of the present invention. The gas generator shown in FIG. 1 is suitable for assembling with an air bag for side collision.

A gas generator 10 includes a pressurized gas chamber 20 filled with a pressurized gas, a gas generation chamber 30 where a solid gas generating agent 50 is disposed, and a diffuser portion 60.

The pressurized gas chamber 20 has a round cross section and has an outer shell formed by a cylindrical pressurized gas chamber housing 22. The pressurized gas chamber is filled with a pressurized gas including a mixture of argon and helium. The pressurized gas chamber housing 22 is symmetrical with respect to the axial and radial directions.

A charging port 24 for a pressurized gas is formed in the side surface of the pressurized gas chamber housing 22, and this port is closed with a pin 26 after the pressurized gas has been loaded.

The outer shell of the gas generation chamber 30 is formed by a gas generation chamber housing 31, and the inside of the gas generation chamber serves as a combustion chamber 32. The gas generation chamber housing 31 and the pressurized gas chamber housing 22 are resistance-welded together in a joint portion 56.

An electric igniter 40 is attached to one end of the combustion chamber 32 (gas generation chamber housing 31), an ignition portion of the igniter 40 is covered with a cup 47 (sometimes also referred to hereinbelow as “ignition portion 47”) and the ignition portion protrudes into the combustion chamber 32. A well-known igniter such as has been generally used in gas generators for airbag apparatuses can be used as the igniter 40, and an igniter of the structure shown in FIG. 2 can be used.

In the igniter 40, an igniter body 41 is fixed via a resin 42 to a metallic collar. The igniter body 41 has a metallic header 43, a cylindrical charge holder 44, and a pair of electroconductive pins 45 for connection to an external power source. The electroconductive pins 45 are disposed so that an electric insulation state is maintained therebetween, and a bridge wire (not shown in the drawing) is bridged between distal end portions thereof. The charge holder 44 also acts to control the ejection direction of a combustion product.

An ignition agent (for example, an explosive including zirconium and potassium perchlorate) 46 is loaded into a depression formed by the metallic header 43 and cylindrical charge holder 44, so that the ignition agent is in contact with the bridge wire. The metallic header 43, cylindrical charge holder 44, and ignition agent 46 are covered with the cup 47. A portion that is covered with the cup 47 and generates a combustion product when the igniter 40 is activated serves as an ignition portion (ignition portion 47).

The cup 47 can be formed of a metal (aluminum or the like) or a non-metal (synthetic resin or the like). When a metallic cup 47 is used, a thin insulating film is formed on the surface of cup 47 to maintain electric insulation.

A solid gas generating agent 50 in the form of a cylindrical column having a single through hole 51 in the longitudinal direction in the central portion thereof is accommodated inside the combustion chamber 32. The through hole 51 has a round cross section in the width direction.

An end surface 52 of the solid gas generating agent 50 is directly opposite, via a gap, to an apex surface 47a of the ignition portion 47 of the igniter 40, and the central axis of the gas generator 10, the central axis of the solid gas generating agent 50 (through hole 51), and the central axis X of the igniter 40 (ignition portion 47) coincide.

A gap may be formed between the end surface 52 and the apex surface 47a of the ignition portion by inserting a donut-shaped cushion member between the end surface 52 and the igniter 40. In this case, the apex surface 47a is positioned in the opening portion of the donut-shaped cushion member and only the circumferential edge portion of the end surface 52 is in contact with an annular surface of the cushion member, so as not to inhibit the combustion of the solid gas generating agent 50. The cushion member may be combustible or incombustible, but a combustible cushion member formed from silicone or the like is preferred.

The solid gas generating agent is accommodated in a state in which a circumferential surface 53 of the solid gas generating agent 50 is in contact with an inner wall surface 32a of the combustion chamber 32 and a circumferential edge portion of the end surface 54 of the agent is in contact with an inner wall inclined surface 32b of the chamber. Because the outer diameter of the solid gas generating agent 50 is almost equal to the inner diameter of the combustion chamber 32, the circumferential surface 53 abuts against the inner wall surface 32a of the combustion chamber 32. As a result, the solid gas generating agent 50 is prevented from moving in the radial direction and toward the pressurized gas chamber 20, and even when vibrations are applied to the gas generator 10 from the outside, the solid gas generating agent 50 is prevented from moving and generating abnormal sound or from being pulverized.

The solid gas generating agent 50 can include, for example, nitroguanidine as a fuel, strontium nitrate as an oxidizing agent, and sodium salt of carboxymethyl cellulose as a binder. Furthermore, if necessary, potassium perchlorate may be added or a Japanese acid clay may be added to trap a residues.

An outer diameter D₁ (apparent outer diameter of the ignition portion) of the ignition portion (cup) 47 is set to be larger than an inner diameter d₁ of the through hole 51 (D₁>d₁). Further, when the igniter 40 has the charge holder 44, as shown in FIG. 2, an inner diameter D₂ (true outer diameter of the ignition portion) of the charge holder 44 is set to be larger than an inner diameter d₁ of the through hole 51 (D₂>d₁).

When the D₁>d₁ condition is satisfied, the ignition portion 47 of the igniter is prevented from entering the through hole 51 even when the solid gas generating agent 50 moves toward the igniter 40.

When the D₂>d₁ condition is satisfied and also because the circumferential surface 53 and the inner wall surface 32a of the combustion chamber 32 abut against each other without a gap, the combustion product, generated when the igniter 40 is actuated, comes easily into contact with the end surface 52 and the inner wall surface of the through hole 51, and is prevented from passing inside the through hole 51 and exiting therefrom at the end surface 54.

Thus, when the two conditions, D₁>d₁ and D₂>d₁, are satisfied, the solid gas generating agent 50 is uniformly combusted with good reproducibility by being ignited and burnt from the end surface 52 and the inner wall surface 51a of the through hole 51. Furthermore, the solid gas generating agent 50 is easily broken into pieces by the impact wave in the combustion product, thereby also contributing to the above-described improvement of combustion. Thus, because gas is discharged from the combustion chamber in a state of complete combustion of the solid gas generating agent 50, the output of the gas generator 10 is stabilized. Moreover, because the solid gas generating agent 50 is broken into pieces, the output pressure rises rapidly and increases.

D₁=8 mm>d₁=3 mm is a specific example of D₁>d₁, and D₂=4 mm>d₁=3 mm is a specific example of D₂>d₁.

In addition to the shape shown in FIG. 1, the solid gas generating agent 50 may have shapes shown in FIG. 3 and FIG. 4.

In a solid gas generating agent 150 shown in FIG. 3, a plurality of (six as shown in FIG. 3) cylindrical column shaped molded articles 150a having no through holes are disposed so as to form together a circle, and a through hole 151 is formed in the central portion of the circle. With the through hole 151 of a plan view shape such as shown in FIG. 3, the surface area of internal wall surface of the through hole 151 increases, thereby improving ignition ability.

The solid gas generating agent 150 may have a configuration in which a plurality of (for example six to ten) cylindrical column shaped molded articles are disposed without being integrated, a configuration in which a plurality of (for example six to ten) cylindrical column shaped molded articles are disposed and integrated, and a configuration in which an integrated molded article of the shape shown in FIG. 3 is disposed.

When the solid gas generating agent 150 shown in FIG. 3 is applied to the gas generator 10 shown in FIG. 1, the solid gas generating agent is disposed so that the central axis of the through hole 151 matches the central axis of the igniter 40. The relationships D₁>d₂ and D₂>d₂ are satisfied, where d₂ stands for an inner diameter (maximum diameter) of the through hole 151. The outer diameter of the solid gas generating agent 150 is an outer diameter of an osculating circle shown by a broken line in FIG. 3.

In the solid gas generating agent 150 shown in FIG. 3, a gap is formed between the outer surface of the gas generating agent and the inner wall surface 32a of the combustion chamber, but by increasing the number of the cylindrical column shaped molded articles that are combined together, it is possible to increase the surface area of contact with the inner wall surface 32a of the combustion chamber, reduce the gap, and increase the surface area of the inner wall surface of the through hole 151.

In a solid gas generating agent 250 shown in FIG. 4, a through hole 251 is formed in the central portion of a cylindrical column shaped molded article and also a plurality of through holes 252 (six in FIG. 4) having an inner diameter smaller than the inner diameter of the through hole 251 are arranged around the through hole 251. By thus forming a plurality of through holes with a different inner diameter, the total surface area of the inner wall surface of all the through holes is increased in the same manner as in the configuration shown in FIG. 3. Therefore, the ignition ability is improved. The inner diameter of the through hole 251 is preferably 6.5 mm or less and the inner diameter of the through holes 252 is preferably 3.5 mm or less in order to prevent the combustion products from passing through the through holes.

When the solid gas generating agent 250 shown in FIG. 4 is applied to the gas generator 10 shown in FIG. 1, the solid gas generating agent is disposed so that the central axis of the through hole 251 matches the central axis of the igniter 40. The relationships D₁>d₃ and D₂>d₃ are satisfied, where d₃ stands for an inner diameter of the through hole 251. It is also preferred that the relationships D₁>d₄ and D₂>d₄ be satisfied, where d₄ stands for a spacing between two opposing through holes 252.

A first communication hole 57 between the pressurized gas chamber 20 and gas generation chamber 30 is closed with a first rupturable plate 58, and a the inside of the gas generation chamber 30 is maintained under a ambient pressure. The first rupturable plate 58 is resistance-welded to the gas generation chamber housing 31 in a circumferential edge portion 58a. Under the pressure of the pressurized gas charged into the pressurized gas chamber 20, the first rupturable plate is deformed, assuming a bowl-like shape, toward the gas generation chamber 30.

A diffuser portion 60 having a gas discharge port 62 for discharging the pressurized gas and combustion gas is connected to the other end of the pressurized gas chamber 20. The diffuser portion 60 and the pressurized gas chamber housing 22 are resistance-welded at a joint portion 64. The diffuser portion 60 has a cap-like shape having a plurality of gas discharge ports 62 through which gases can pass.

A second communication hole 66 between the pressurized gas chamber 20 and diffuser portion 60 is closed with a second rupturable plate 68, and the inside of the diffuser portion 60 is maintained under a ambient pressure. The second rupturable plate 68 is resistance-welded to the diffuser portion 60 at a circumferential edge portion 68a. Under the pressure of the pressurized gas charged into the pressurized gas chamber 20, the second rupturable plate is deformed, assuming a bowl-like shape, toward the diffuser portion 60.

The operation of the gas generator 10 shown in FIG. 1 where it is assembled with an airbag system installed on an automobile will be described below.

When an automobile collides and receives the impact, the igniter 40 is actuated and ignited by an actuation signal output device, the solid gas generating agent 50 is ignited and combusted and a combustion product is generated. The combustion product comes into contact with the end surface 52 and the inner wall surface 51a of the through hole 51 of the solid gas generating agent 50, combustion is started, and combustion gas is generated. The pressure inside the combustion chamber 32 then rises, and the first rupturable plate 58 is ruptured. The combustion gas then flows into the pressurized gas chamber housing 22, mixes with the pressurized gas, further rises the pressure, ruptures the second rupturable plate 68 and is released from the diffuser 60.

In comparison of a gas generator 10 shown in FIG. 1 with that having the same dimensions but the relationship D₂<d₁ in terms of the molded article of the gas generating composition 50, an output of the gas generator 10 (for example, evaluated by the maximum pressure in a well-known 60-liter tank test) less varies.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator for a restraining device for a vehicle, comprising
a combustion chamber accommodating a solid gas generating agent therein,
an igniter for igniting and burning the solid gas generating agent,
the solid gas generating agent having a columnar shape and a through hole in the central portion thereof in the longitudinal direction,
an ignition portion of the igniter being disposed to face one end surface of the solid gas generating agent,
an outer diameter of the ignition portion being smaller than an outer diameter of the solid gas generating agent and larger than an inner diameter of the through hole.

2. The gas generator for a restraining device for a vehicle according to claim 1, wherein at least part of circumferential surface and part of end surface of the solid gas generating agent is brought into contact with an inner wall surface of the combustion chamber, thereby preventing the solid gas generating agent from moving in the axial direction and the radial direction.

3. The gas generator for a restraining device for a vehicle according to claim 1, wherein
the ignition portion has a cylindrical charge holder and an ignition agent loaded into the cylindrical charge holder, and the cylindrical charge holder and the ignition agent are covered with a cup member, and
an inner diameter of the charge holder is larger than an inner diameter of the through hole.

4. The gas generator for a restraining device for a vehicle according to claim 2, wherein
the ignition portion has a cylindrical charge holder and an ignition agent loaded into the cylindrical charge holder, and the cylindrical charge holder and the ignition agent are covered with a cup member, and
an inner diameter of the charge holder is larger than an inner diameter of the through hole.
